(19) United States
(12) Patent Application Publication
(10) Pub. No.: US 2025/0254538 A1
(43) Pub. Date: Aug. 7, 2025

(54) Methods And Apparatus For Internet-Of-Things Signal Transmission In Mobile Communications

(71) Applicant: MediaTek Singapore Pte. Ltd., Singapore (SG)

(72) Inventors: JunQiang Cheng, Beijing (CN); Tao Chen, Beijing (CN); Chiou-Wei Tsai, Hsinchu City (TW); Wei-De Wu, Hsinchu City (TW); Chien-Chun Cheng, Hsinchu City (TW); Tai-Cheng Tsai, Hsinchu City (TW)

(21) Appl. No.: 19/010,287

(22) Filed: Jan. 6, 2025

(30) Foreign Application Priority Data
Feb. 6, 2024 (WO) PCT/CN2024/076383
Dec. 31, 2024 (CN) 202411987019.X

(51) Int. Cl. H04W 24/02; H04L 1/00; H04W 56/00; H04W 72/231

(52) U.S. Cl. CPC H04W 24/02; H04L 1/0061; H04W 56/0015; H04W 72/231

(57) ABSTRACT

Various solutions for Internet of Things (IoT) signal transmission with respect to an apparatus, a network node and an IoT device are described. An apparatus may receive a configuration from a network node. The apparatus may transmit a command to an IoT device according to the configuration. The apparatus may receive a backscattered signal from the IoT device. The backscattered signal is generated based on a carrier wave (CW). The CW may be provided by the apparatus or an emitter.

### CROSS REFERENCE TO RELATED PATENT APPLICATION(S)

The present disclosure is part of a non-provisional application claiming the priority benefit of PCT Application No. PCT/CN2024/076383, filed 6 Feb. 2024, and CN Application No. 202411987019.X, filed 31 Dec. 2024. The contents of aforementioned applications are herein incorporated by reference in their entirety.

### TECHNICAL FIELD

The present disclosure is generally related to mobile communications and, more particularly, to internet of things (IoT) signal transmission with respect to reader apparatus and IoT device in mobile communications.

### BACKGROUND

Unless otherwise indicated herein, approaches described in this section are not prior art to the claims listed below and are not admitted as prior art by inclusion in this section.

Wireless communication systems may be widely deployed to provide various telecommunication services such as telephony, video, data, messaging, and broadcasts. Typical wireless communication systems may use multiple-access technologies capable of supporting communication with multiple users by sharing available system resources. Examples of such multiple-access technologies may include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G long term evolution (LTE) standard. There exists a need for further improvements in 5G NR technology. These improvements may also be applicable to other multi-access technologies and the telecommunication standards that employ these technologies.

Ambient IoT (A-IoT) communication may be a critical component of future wireless communication. Typically, an A-IoT device may need to achieve low complexity and low power consumption. Therefore, the backscattering technic may be an appropriate approach for the A-IoT communication.

Accordingly, how to perform the A-IoT communication in the wireless communication environments such as 5G NR becomes an important issue for the newly developed wireless communication network.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to Internet of Things (IoT) signal transmission with respect to apparatus (e.g., a reader and/or an emitter), network node and IoT device in mobile communications. It is believed that the above-described issue would be avoided or otherwise alleviated by implementing one or more of the proposed schemes described herein.

In one aspect, a method may involve an apparatus receiving a configuration from a network node. The method may also involve the apparatus transmitting a command to an IoT device according to the configuration. The method may further involve the apparatus receiving a backscattered signal from the IoT device. The backscattered signal is generated based on a CW.

In another aspect, a method may involve a network node transmitting a CW to an IoT device via an emitter. The method may also involve the network node transmitting a command to the IoT device. The method may further involve the network node receiving a backscattered signal from the IoT device. The backscattered signal is generated based on the command and the CW.

In another aspect, a method may involve a network node determining a configuration for a user equipment (UE). The configuration may indicate an operation mode of the UE for a communication between the UE and an IoT device. The method may also involve the network node transmitting the configuration to the UE.

In another aspect, a method may involve an IoT device receiving a command from a reader. The method may also involve the IoT device receiving a CW from the reader or an emitter. The method may further involve the IoT device transmitting a backscattered signal to the reader. The backscattered signal is generated based on the CW.

It is noteworthy that, although description provided herein may be in the context of certain radio access technologies, networks and network topologies such as 5th Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), 6th Generation (6G), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario for an A-IoT topology in accordance with implementations of the present disclosure.

FIG. 3 is a diagram depicting another example scenario for an A-IoT topology in accordance with implementations of the present disclosure.

FIG. 4 is a diagram depicting another example scenario for an A-IoT topology in accordance with implementations of the present disclosure.

FIG. 5 is a diagram depicting another example scenario for an A-IoT topology in accordance with implementations of the present disclosure.

FIG. 6 is a block diagram of an example communication system in accordance with an implementation of the present disclosure.

FIG. 7 is a flowchart of an example process in accordance with an implementation of the present disclosure.

FIG. 8 is a flowchart of an example process in accordance with another implementation of the present disclosure.

FIG. 9 is a flowchart of an example process in accordance with another implementation of the present disclosure.

FIG. 10 is a flowchart of an example process in accordance with another implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to Internet of Things (IoT) signal transmission with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

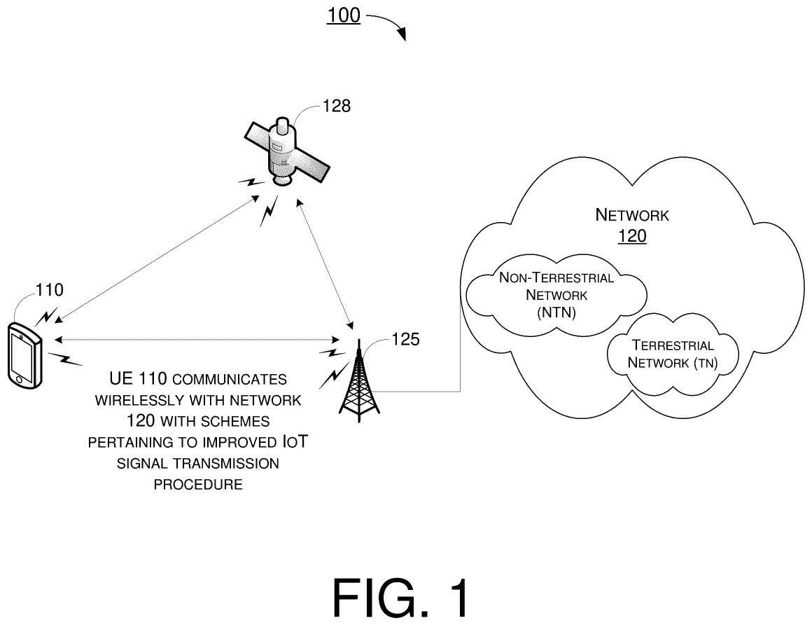

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 125 (e.g., an evolved Node-B (eNB), a Next Generation Node-B (gNB), or a transmission/reception point (TRP)) and/or a non-terrestrial network node 128 (e.g., a satellite). For example, the terrestrial network node 125 and/or the non-terrestrial network node 128 may form a non-terrestrial network (NTN) serving cell for wireless communication with the UE 110. In some implementations, the UE 110 may be an IoT device such as an NB-IoT UE or an enhanced machine-type communication (eMTC) UE (e.g., a bandwidth reduced low complexity (BL) UE or a coverage enhancement (CE) UE). In such communication environment, the UE 110, the network 120, the terrestrial network node 125, and the non-terrestrial network node 128 may implement various schemes pertaining to improved IoT signal transmission procedure in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

According to the implementations of the present disclosure, in an IoT topology (e.g., topology 1), a network node may transmit a carrier wave (CW) to an Internet of Things (IoT) device (e.g., an ambient IoT (A-IoT) device) via an emitter. The network node may also transmit a command to the IoT device. In addition, the network node may receive a backscattered signal from the IoT device. The backscattered signal may be generated based on the command and the CW.

In an implementation, the network node may comprise the emitter. That is, the network node may have two functions including reader and emitter in the IoT communication, i.e., the network node can directly transmit the CW to the IoT device. In another implementation, the network node may only have the function of reader in the IoT communication, i.e., the network node may transmit the CW to the IoT device through an emitter. For example, the network node may transmit an instruction to the emitter (e.g., via wired or wireless signal) and instruct the emitter to transmit the CW to the IoT device.

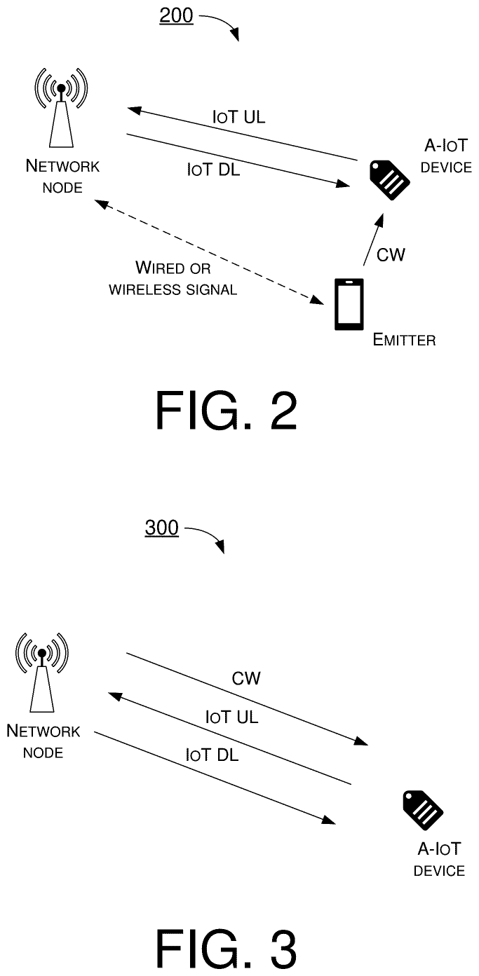

FIG. 2 illustrates an example scenario 200 for an A-IoT topology in accordance with implementations of the present disclosure. Scenario 200 involves an emitter, an A-IoT device (e.g., a tag) and a network node (e.g., a (macro/micro) base station) which may be a part of a wireless network (e.g., an LTE network, a 5G/NR network, an IoT network or a 6G network). Referring to FIG. 2, the A-IoT topology may comprise a network node (i.e., a reader of IoT communication) and an A-IoT device. In addition, there may be an emitter to provide a carrier wave (CW) to the A-IoT device.

The network node may transmit an A-IoT downlink (DL) (or forward link) signal to the A-IoT device. The A-IoT device may transmit an A-IoT uplink (UL) (or backward link) signal to the network node via the backscattering. The backscattering may be performed based on the CW provided by the emitter. The A-IoT DL signal transmitted to the A-IoT device may be used to communicate with the A-IoT device or to provide scheduling to the A-IoT device. The A-IoT DL signal may be started with a dedicated sequence. The dedicated sequence may be (pre-)defined, (pre-)configured, and/or indicated. The dedicated sequence can be used for the synchronization of the A-IoT device.

The A-IoT device may use the CW for backscattering. Specifically, the A-IoT device may modulate the CW with its data. In addition, the network node may schedule the data type through the A-IoT DL signaling. Because the A-IoT device may not generate its own radio frequency (RF) energy, the A-IoT device may modulate and reflect the incident CW for the data transmission. The network node may schedule the operations (e.g., modulation, coding scheme) performed by A-IoT device on the CW through the A-IoT DL signaling. The A-IoT device may transmit the A-IoT UL signal back to the network node via the backscattering of the modulated CW.

As shown in FIG. 2, there may be a communication link between the network node and the emitter. The communication link may be wired link or wireless link for delivering signaling between the network node and the emitter. The network node may transmit the scheduling or control information for the CW provision through the communication link. For example, the network node may transmit the signaling (e.g., scheduling or control information) to the emitter through the Uu interface (i.e., the communication link) for scheduling the resource and power for the CW transmission.

The emitter may have different CW provision mode. For example, the CW provision may be contiguous, periodic, and/or on-demand based on a triggering. That is, according to the triggering, the CW may be transmitted contiguously, periodically or based on a demand. The triggering may be a configuration and/or a scheduling from the network node via a radio resource control (RRC) signaling, a medium-access-control control-elements (MAC CE), and/or a downlink control information (DCI). The resource allocation for CW transmission from emitter may be scheduled by the network node. For example, the network node may allocate a specific time slot, a frequency block, and/or a code for the emitters to provide the CW, and for the A-IoT device to backscatter the incoming CW. The time slots may be NR Uu UL slots, and/or NR Uu DL slots. The frequency block may be a channel, and/or a sub-channel in the frequency domain. In an example, the unique code may be a random or pseudo-random sequence which is (pre-)defined, (pre-)configured, or indicated by the network node. In another example, the unique code may be generated by the A-IoT device.

In addition, the network node may transmit the scheduling information to the emitter. The scheduling information may indicate when to provide the CW to the A-IoT device. The scheduling information may be determined based on a predetermined pattern or a dynamic decision based on the network conditions. For example, the network node may schedule the emitter to transmit CW immediately after the A-IoT DL signal is transmitted from the network node to the A-IoT device. In another example, the network node may schedule the emitter to transmit CW at least a period of time (e.g., T) preceding the time slot where the A-IoT device performs backscattering. The network node may indicate the emitter to adjust the power level of the CW based on at least one of the distance between the emitter and the A-IoT device, the distance between the emitter and network node, and the quality of the backscattered signal. The A-IoT device may backscatter the information about the channel conditions, which the network node may use to optimize the communication strategy, such as adjusting the scheduling or power control. The network node may transmit the error correction codes or the request retransmission of data if the backscattered signal from the A-IoT device is not received correctly. The network node may transmit the configuration updates to the emitter or the A-IoT device, such as changes in the modulation/coding scheme, a time-division duplexing (TDD) pattern, a resource allocation, or protocol parameters to improve system performance.

FIG. 3 illustrates another example scenario 300 for an A-IoT topology in accordance with implementations of the present disclosure. Scenario 300 involves an A-IoT device (e.g., a tag) and a network node (e.g., a (macro/micro) base station) which may be a part of a wireless network (e.g., an LTE network, a 5G/NR network, an IoT network or a 6G network). Referring to FIG. 3, the A-IoT topology may comprise a network node (i.e., a reader of IoT communication) and an A-IoT device. In addition, in this A-IoT topology, the network node may provide a carrier wave (CW) to the A-IoT device (i.e., the network node comprises the emitter function).

As shown in FIG. 3, the network node may transmit an A-IoT DL signal to the A-IoT device, and the A-IoT device may transmit an A-IoT UL signal to the network node via backscattering. The backscattering may be performed based on the incoming CW provided by the network node. The A-IoT DL signal transmitted to the A-IoT device may comprise the information or commands for the A-IoT device. The network node may transmit the CW to the A-IoT device. The transmission time of the CW may be at least a period of time (e.g., T) before the backscattered reply of the A-IoT device. The A-IoT device may reflect the incident CW from the network node. Specifically, the A-IoT device may add its own information (e.g., varying the reflection properties of its antenna/circuity, effectively modulating the signal) or data onto the CW, and transmit the CW to the network node by backscattering. The network node may receive the backscattered signal from the A-IoT device, i.e., the A-IoT UL signal which may contain the data from the A-IoT device.

The CW provided by the network node may be contiguous, and/or periodic, and/or on-demand. That is, according to the triggering, the CW may be transmitted contiguously, periodically or based on a demand. The CW transmission and resource allocation for CW may be scheduled by the network node. For example, the network node may allocate the specific time slots for transmitting the A-IoT DL signal and for CW transmission. In an example, the receiving of the A-IoT UL signal from the A-IoT device may happen on the same slot as the CW transmission if the A-IoT UL transmission is backscattered on a CW provided externally. In another example, the receiving of the A-IoT UL signal from the A-IoT device may happen on a different slot compared to the CW transmission slot if the A-IoT UL transmission is generated internally by the A-IoT device. Alternatively, the network node may use one frequency for the DL signal and a different frequency for the CW transmission. For example, the frequency-division duplexing (FDD) DL spectrum may be used for the A-IoT DL transmission, and the FDD UL spectrum may be used for the CW transmission. The receiving of the A-IoT UL signal from the A-IoT device may happen on the same frequency/channel as the CW transmission frequency/channel if the A-IoT UL transmission is backscattered on a carrier wave provided externally. The receiving of the A-IoT UL signal from the A-IoT device may happen on a different frequency/channel if the A-IoT UL transmission is generated internally by the A-IoT device. The network node may dynamically allocate resources based on the current network load, the number of active A-IoT devices, and the quality of the communication channel.

Referring to FIG. 3, the network node may transmit the scheduling information to the A-IoT device. The scheduling information may indicate the information that when the A-IoT should backscatter its signal. The scheduling information may comprise a slot counter. The network node may control the characteristics of the CW, such as power level based on the distance between network node and the A-IoT device. The network node may indicate the A-IoT to activate or deactivate its backscattering function to conserve the energy when the communication between the network node and the A-IoT device is not required. The network node may acknowledge the successful reception of the backscattered signal. In addition, the network node may request retransmission if the signal was not received correctly. The network node may receive feedback regarding the channel quality from the A-IoT device. The network node may adjust the resource allocation and signaling strategies according to the feedback. The network node may indicate the A-IoT device to adjust its reflection properties to ensure that the backscattered signal is received with sufficient quality.

According to the implementations of the present disclosure, in another IoT topology (e.g., topology 2), a reader apparatus (e.g., UE 110) may receive a configuration from a network node (e.g., a (macro/micro) base station). The reader apparatus may transmit a command to an IoT device according to the configuration. In addition, the reader apparatus may receive a backscattered signal from the IoT device. The backscattered signal may be generated based on a carrier wave (CW). In an example, the reader apparatus may transmit the CW to the IoT device according to the configuration. In another example, an emitter may transmit the CW to the IoT device.

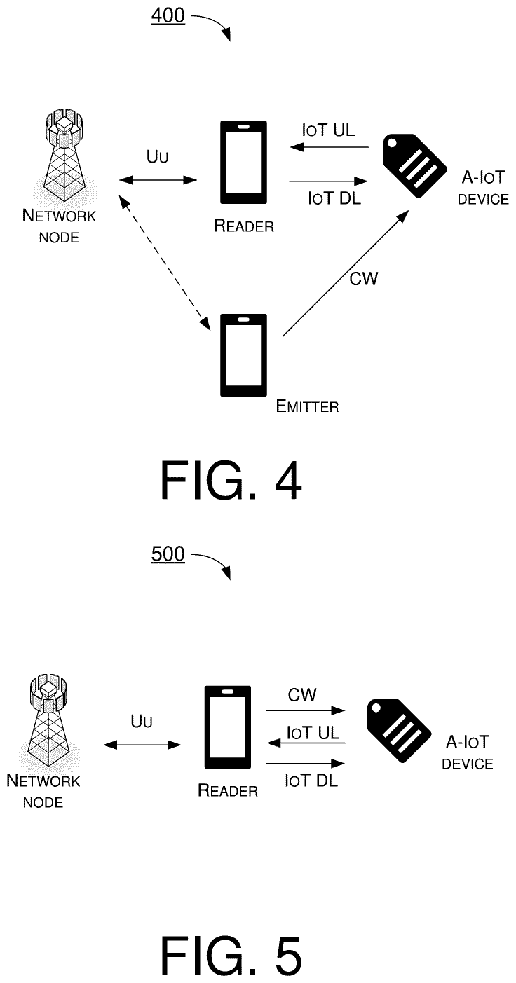

FIG. 4 illustrates another example scenario 400 for an A-IoT topology in accordance with implementations of the present disclosure. Scenario 400 involves a reader (e.g., a UE or a UE reader), an A-IoT device (e.g., a tag), an emitter (e.g., a UE emitter) and a network node (e.g., a (macro/micro) base station) which may be a part of a wireless network (e.g., an LTE network, a 5G/NR network, an IoT network or a 6G network). Referring to FIG. 4, the A-IoT topology may comprise a network node, a UE reader, and an A-IoT device. In addition, a UE emitter may be configured to provide the CW to the A-IoT device.

Referring to FIG. 4, the network node may transmit a signal to the UE reader via the Uu interface. The signal may comprise the scheduling information for the behavior of the UE reader. For example, the network node may schedule the resource for the UE reader to transmit an A-IoT DL signal to the A-IoT device. The scheduling may be performed via higher-layer signaling (e.g., RRC, MAC-CE) or layer 1 (L1) signaling (e.g., DCI). In an example, the network node may transmit a configuration to the UE reader to indicate a resource for the UE reader to transmit an A-IoT DL signal to the IoT device and receive an A-IoT UL signal from the A-IoT device via a higher-layer signaling or an L1 signaling.

The A-IoT device may modulate the CW with its own data by reflecting the CW and adjusting (or altering) its properties to encode the information of the A-IoT device. The A-IoT device may transmit an A-IoT UL signal back to the UE reader via the backscattering of the modulated CW. The UE reader may receive the A-IoT UL signal which contains the data from the A-IoT device.

The link between the network node and the UE emitter (e.g., wired or wireless) may be used for delivering the signaling between the network node and the UE emitter. The signaling between the network node and the UE emitter may comprise coordination for the provision of the CW to the A-IoT device, e.g., the resource allocation. The link between the UE reader and the UE emitter may be used for delivering the signaling between the UE reader and the UE emitter. The signaling between the UE reader and the UE emitter may coordinate the provision of the CW to the A-IoT device, e.g., the resource allocation.

The UE reader and UE emitter may be two operation modes for a UE. The operation modes of the UE (e.g., operating as a UE reader or a UE emitter) may be configured and/or indicated by the network node through RRC, MAC-CE, and/or DCI based on a factor set. For example, one bit in an RRC, an MAC-CE and/or a DCI may be used for the configuration and/or the indication. The factor set may be the distance, and/or the link quality between the UE and the A-IoT device. That is, the network node may determine the configuration or indication based on a distance or a link quality between the UE and the A-IoT device. For example, for the UE with a longer distance from the A-IoT device, the UE may be configured and/or indicated to operate in the UE reader mode (i.e., the UE is a UE reader). For the UE with a shorter distance from the A-IoT device, the UE may be configured and/or indicated to operate in the UE emitter mode (i.e., the UE is a UE emitter).

In addition, referring to FIG. 4, the UE emitter may be configured and/or indicated to operate in different CW provision modes. The CW provision modes may comprise the contiguous, periodic, and/or on-demand modes. That is, the CW may be transmitted contiguously, periodically or based on a demand. The configuration and/or indication for the CW provision may be delivered by the network node through RRC, MAC-CE and/or DCI. The resource allocation can be scheduled by the network node. For example, the network node may allocate specific time slots for the UE reader and the UE emitter to operate. Alternatively, different frequencies or channels or sub-channels or resource pools may be assigned to the UE reader and the UE emitter to operate. Alternatively, different codes (e.g., random and/or pseudo-random sequence) may be assigned to the UE reader and the UE emitter to operate. The A-IoT device may backscatter the incoming CW provided by the external UE emitter. The unique codes (e.g., random and/or pseudo-random sequence) may be used to differentiate between signals from different A-IoT devices. In an example, the unique codes may be (pre-)defined, and/or (pre-)configured by the network node and/or UE reader. In another example, the unique codes may be generated by the A-IoT device. The unique codes may allow multiple A-IoT devices to communicate simultaneously without interference.

In addition, the network node may control the power levels of the signals transmitted by the UE reader and the UE emitter based on a factor set to optimize the backscattering process and ensure that backscattered signal of the A-IoT device is received with sufficient quality. The factor set may comprise at least one of the distance between the UE reader and the A-IoT device, the distance between the UE emitter and the A-IoT device, the distance between the network node and the UE reader, the distance between the network node and the UE emitter, and the distance between the UE reader and the UE emitter. In an implementation, the UE emitter may determine a power of the CW according to at least one of the distance between the UE reader and the UE emitter, the distance between the A-IoT device and the UE emitter, and the distance between the UE reader and the A-IoT device.

Additionally, referring to FIG. 4, the network node may transmit the scheduling information to the UE reader to indicate the resource for the A-IoT DL transmission and the A-IoT UL reception. The network node may transmit the scheduling information to the UE emitter to indicate the resource for CW transmission. Additionally, the network node may transmit commands to configure and/or indicate a UE operation mode. For example, one bit in a DCI and/or one information element (IE) in a RRC parameter may be used for indicating and/or configuring the UE to act as a UE reader and/or a UE emitter. The network node may also transmit commands regarding the resource allocation, power levels, and other operational parameters for the UE reader and the UE emitter. The UE reader may transmit the status updates back to the network node. The status updates of the UE reader may comprise some information, e.g., whether the reception of the backscattered signal from the A-IoT device is successful. In an example, the network node may transmit the information (i.e., status updates) to the UE emitter. In another example, the UE reader may directly transmit the status updates to the UE emitter. In addition, the UE emitter may transmit status updates back to the network node to inform the network node of the current state, e.g., the successful transmission of CW. After receiving the backscattered signal from the A-IoT device, the UE reader may transmit an acknowledgment (ACK) to the A-IoT device, and/or to the network node to confirm the successful communication. Continuous signaling between the network node and the UE emitter, as well as between the UE reader and the external UE emitter, may be necessary to maintain the link quality and synchronization. If errors are detected in the backscattered signal, signaling protocols may be used to request retransmission or to adjust system parameters (e.g., transmission power) to improve the communication quality.

FIG. 5 illustrates another example scenario 500 for an A-IoT topology in accordance with implementations of the present disclosure. Scenario 500 involves a reader (e.g., a UE or a UE reader), an A-IoT device (e.g., a tag) and a network node (e.g., a (macro/micro) base station) which may be a part of a wireless network (e.g., an LTE network, a 5G/NR network, an IoT network or a 6G network). Referring to FIG. 5, the A-IoT topology may comprise a network node, a UE reader, and an A-IoT device. In addition, in the A-IoT topology, the UE reader may provide a CW to the A-IoT device (i.e., the UE reader may comprise the emitter function).

The network node may transmit a signal to the UE reader via the Uu interface to schedule the behavior of the UE reader. The scheduling signal may comprise the information about when the UE reader should transmit CW to the A-IoT device, when the UE reader should listen for the A-IoT UL signal from the A-IoT device, and when the UE reader should transmit the A-IoT DL signal to the A-IoT device. The UE reader may transmit an A-IoT DL signal to the A-IoT device. The transmission of the A-IoT DL signal can be based on the scheduling determined by the network node or based on a determination made by the UE reader itself. The A-IoT DL signal may comprise data or commands for the A-IoT device. Upon receiving the A-IoT DL signal, the A-IoT device may transmit an A-IoT UL signal back to the UE reader via backscattering of the CW which is provided by the UE reader. In backscattering communication, the A-IoT device may modulate the incident CW with its own data and reflects the modulated CW back towards the UE reader.

Additionally, referring to FIG. 5, the UE reader may have different CW provision modes. The CW provision modes may comprise contiguous, periodic, and/or on-demand modes. That is, the CW may be transmitted contiguously, periodically or based on a demand. The CW provision mode may be configured and/or scheduled by the network node via RRC, and/or MAC-CE, and/or DCI. In addition, the resource allocation can be scheduled by the network node. For example, the network node may allocate specific time slots for the UE reader to transmit the A-IoT DL signal and the CW. Alternatively, the network node may allocate different frequencies for the A-IoT DL signal transmission and the CW transmission. Alternatively, the network node may control the power levels of the A-IoT DL transmission and the CW transmission from the UE reader to ensure that the A-IoT device can effectively backscatter the signal and that the backscattered signal can be received with sufficient quality.

Additionally, referring to FIG. 5, the network node may transmit the scheduling information to the UE reader to indicate when to transmit the DL signal to the A-IoT device, when to transmit the CW to the A-IoT device, and when to listen for the backscattered UL signal from the A-IoT device. The network node may transmit configuration commands to the UE reader to set the operational parameters, e.g., the power levels, frequencies, and time slots for communication with the A-IoT device. The UE reader may transmit the status messages to the network node to indicate the state of the communication with the A-IoT device. In addition, the UE reader may receive the control messages to adjust its operation as needed. The UE reader may transmit acknowledgments (ACKs) to the network node after successfully receiving the backscattered signal from the A-IoT device or transmit a non-acknowledgment (NACK) to the network node if there is no transmission from the A-IoT device in a specific duration. If errors are detected, signaling protocols may manage retransmission requests.

In the implementations of the present disclosure, the configuration/scheduling signal may be carrier in RRC, MAC-CE, DCI, channel state information (CSI), 1st stage sidelink control information (SCI), and/or 2nd stage SCI. For example, the RRC signaling may be used to handle the configuration of the UE reader. The configuration may comprise the operation mode of the UE (e.g., a reader or an emitter), the transmission pattern (e.g., time division multiplexing (TDM) pattern and/or frequency division multiplexing (FDM) configuration), and the CW provision mode (contiguous, periodic, and/or on-demand mode). In another example, the MAC-CE and/or DCI signaling may be used for the dynamic resource allocation and used to provide instructions on the timing and format of the transmissions.

In the implementations of the present disclosure, the command from the reader (e.g., a network node or a UE reader) to the IoT device (e.g., A-IoT device) may comprise a timing acquisition signal, and wherein the timing acquisition signal comprises at least a start-indicator part and a clock-acquisition part. The command may start with at least one of a synchronization (sync) preamble and a frame-sync sequence. The sync preamble may comprise at least a fixed length, a start delimiter (e.g., the start-indicator part), a reader-to-tag calibration symbol (e.g., clock-acquisition part), and a tag-to-reader calibration symbol. The frame-sync sequence may comprise at least a fixed length start delimiter, a reader-to-tag calibration symbol.

In the implementations of the present disclosure, the command from the reader (e.g., a network node or a UE reader) to the IoT device (e.g., A-IoT device) may indicate an IoT UL type associated with a UL timing. Specifically, the reader (e.g., a network node or a UE reader) may schedule the reply timing of the IoT device (e.g., A-IoT device). For example, an indication may be carried in the A-IoT DL signal from the reader to schedule the timing of the A-IoT UL signal (i.e., the reply of the IoT device) from the IoT device. The timing of A-IoT UL may be an immediate/real time A-IoT UL. It means that the IoT device may transmit A-IoT UL signal within a duration of time (e.g., T1) after the IoT device receive the A-IoT DL signal from the reader.

In another example, the timing of A-IoT UL may be a delayed A-IoT UL. It means that the IoT device may transmit the A-IoT UL signal within a duration of time (e.g., T2) after the IoT device receives the A-IoT DL signal from reader. In addition, after the IoT device issues a scheduling for the delayed reply (e.g., the delayed A-IoT UL), the reader may transmit CW for at least the lesser of T3 or T2 (max). T3 is the time duration between the scheduling of the reader (i.e., A-IoT DL) and the backscattered reply of the IoT device (i.e., A-IoT UL). The max value of T2 should be no less than the max value of T1.

The backscattered reply (or backscattered signal) of the IoT device may comprise a preamble, a header, a handle (e.g., a random number (e.g., 16-bit random number) or a pseudo-random number generated by the of the IoT device in the beginning of the communication round) of the IoT device, and a cyclic redundancy check (CRC) code calculated based on the header and handle. The preamble may comprise one of Manchester preamble, FMO preamble, Miller preamble, convolution preamble, a Barker code, a frame-sync sequence, and/or a sync preamble used in A-IoT DL. One bit in the header in the backscattered reply (e.g., A-IoT UL) of the IoT device can be used to indicate whether the scheduling from reader is successfully executed by the IoT device (e.g., one bit in header=0), or an error is encountered by the IoT device (e.g., one bit in header=1). If the reader does receive the backscattered reply of the IoT device within T2 (max), the reader can issue a subsequent sequence (containing the handle of the IoT device) to verify that the IoT device is still in the energizing coverage of the reader.

In another example, the timing of A-IoT UL may be an in-process A-IoT UL. It means that the IoT device can transmit A-IoT UL within a duration longer than T2. In addition, for an in-process scheduling, multiple backscatters may be transmitted by the IoT device. The first A-IT UL may meet T4 limits. It means that the first A-IoT UL should be transmitted by the IoT device within T4 after the IoT device receives the A-IoT DL from reader. The subsequent A-IoT UL may meet T5 limit. It means the subsequent A-IoT UL should be transmitted by the IoT device within T5 after the immediately previous A-IoT UL. There should be at least one A-IoT UL from IoT device within each T5.

One field in the reply of the IoT device can be used to indicate whether the reply of the IoT device is the last one or not. For example, a field “done” of 0 may mean that the corresponding A-IoT UL is not the last one. A field “done” of 1 may mean that the corresponding A-IoT UL is the last one. In an example, after issuing an in-process reply scheduling, the reader may transmit the CW until the reader receive an A-IoT UL with “done”=1. The A-IoT UL with “done”=1 may indicate the IoT device has finished executing the scheduling from reader. In another example, the reader may transmit the CW until the reader fails to receive an A-IoT UL for at least T4 (max) or T5 (max). It may mean that the IoT device failed to execute the scheduling from reader.

In an implementation of the present disclosure, a sync-sequence (e.g., Barker code) may be added in the backscattering modulated CW (i.e., A-IoT UL) (e.g., preceding the A-IoT UL), if the corresponding A-IoT UL is not the first A-IoT UL in an A-IoT UL burst (a series of A-IoT UL transmissions).

In the present disclosure, there may be a common procedure between the reader and the IoT device for some purpose. For example, the common procedure may comprise “in the initial stage”, “before link establishment”, and/or “for load control”. In addition, there may be a dedicated procedure between the reader and the IoT device for some purpose. For example, the dedicated procedure may comprise “after link establishment”, “for data transmission”, and/or “for transmission repetition”.

In the present disclosure, six logical entities (functionalities) are defined. The six logical entities (functionalities) may comprise a controller, a CW emitter, an IoT command (CMD) generator, a reader, an IoT device, and an energy provider. The controller (e.g., network node) may be used to control CW resources and the corresponding backscattering resource/interference, and/or to schedule and control the operation with interference avoidance. The CW emitter (e.g., a network node, a UE or an external emitter) may be used to generate CW. The CW emitter may communicate with controller for the proper timing to generate CW. The IoT command generator (e.g., a network node or a UE) may be used to generator to generate command based on the resource allocation from controller. The reader (e.g., a network node or a UE) may be used to receive the backscattering signals. The IoT device may be used to decode the command, harvest the energy from the command, CW, and/or external energy harvesting waveform provided by the energy provider, and/or generate the backscattering signal over the CW (and/or the command). The energy provider (e.g., a reader, a controller, etc.) may be used to provide the energy for IoT device to decode the command. In an IoT topography (e.g., topology 1 shown in FIG. 2 and FIG. 3) in the present disclosure, the network node may take the roles of the controller, CW emitter, and reader. In another IoT topography (e.g., topology 2 shown in FIG. 4 and FIG. 5) in the present disclosure, the reader (e.g., UE reader) and resource controller (e.g., network node) can be different physical entities. Additionally, in both topology 1 and topology 2, the emitter may be an individual device compared to the network node and the UE (or UE reader).

### Illustrative Implementations

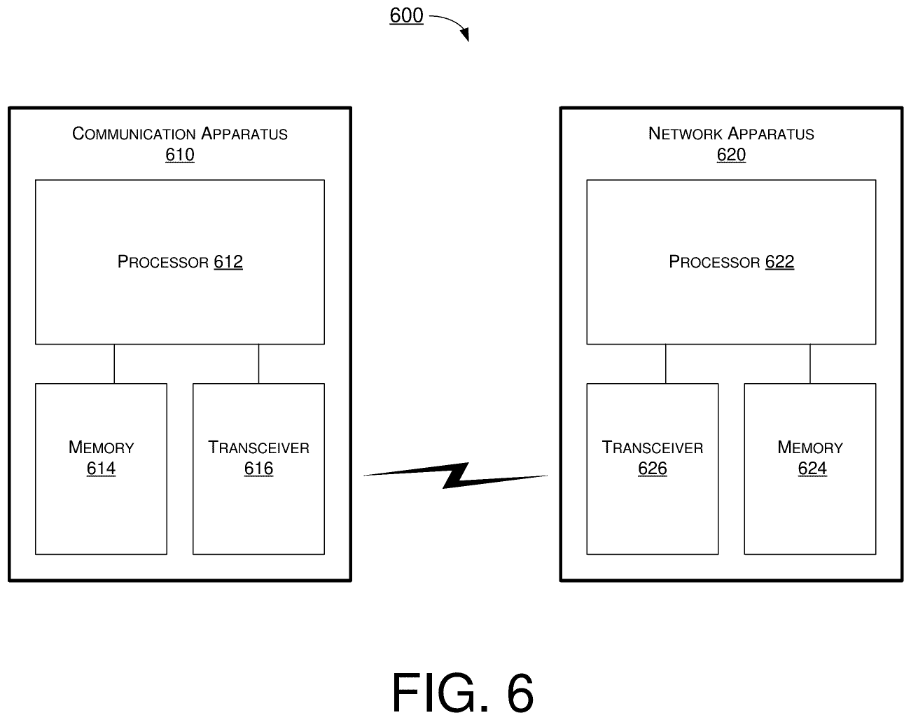

FIG. 6 illustrates an example communication system 600 having at least an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to IoT signal transmission, including the various schemes described above with respect to various proposed designs, concepts, schemes and methods described above and with respect to user equipment and network apparatus in mobile communications, including scenarios/schemes described above as well as process 700, process 800, process 900 and process 1000 described below.

Communication apparatus 610 may be a part of an electronic apparatus, which may be a UE such as a portable or mobile apparatus, a wearable apparatus, a wireless communication apparatus or a computing apparatus. For instance, communication apparatus 610 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 610 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 610 may include at least some of those components shown in FIG. 6 such as a processor 612, for example. Communication apparatus 610 may further include one or more other components not pertinent to the proposed schemes of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of an electronic apparatus, which may be a network node such as a satellite, a BS, a small cell, a router or a gateway of an IoT network. For instance, network apparatus 620 may be implemented in a satellite or an eNB/gNB/TRP in a 4G/5G/B5G/6G, NR, IoT, NB-IoT or IIoT network. Alternatively, network apparatus 620 may be implemented in the form of one or more IC chips such as, for example and without limitation, one or more single-core processors, one or more multi-core processors, or one or more RISC or CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks, including IoT signal transmission, in a device (e.g., as represented by communication apparatus 610) and a network node (e.g., as represented by network apparatus 620) in accordance with various implementations of the present disclosure.

In some implementations, communication apparatus 610 may also include a transceiver 616 coupled to processor 612 and capable of wirelessly transmitting and receiving data. In some implementations, transceiver 616 may be capable of wirelessly communicating with different types of UEs and/or wireless networks of different radio access technologies (RATs). In some implementations, transceiver 616 may be equipped with a plurality of antenna ports (not shown) such as, for example, four antenna ports. That is, transceiver 616 may be equipped with multiple transmit antennas and multiple receive antennas for multiple-input multiple-output (MIMO) wireless communications. In some implementations, network apparatus 620 may also include a transceiver 626 coupled to processor 622. Transceiver 626 may include a transceiver capable of wirelessly transmitting and receiving data. In some implementations, transceiver 626 may be capable of wirelessly communicating with different types of UEs of different RATs. In some implementations, transceiver 626 may be equipped with a plurality of antenna ports (not shown) such as, for example, four antenna ports. That is, transceiver 626 may be equipped with multiple transmit antennas and multiple receive antennas for MIMO wireless communications.

In some implementations, communication apparatus 610 may further include a memory 614 coupled to processor 612 and capable of being accessed by processor 612 and storing data therein. In some implementations, network apparatus 620 may further include a memory 624 coupled to processor 622 and capable of being accessed by processor 622 and storing data therein. Each of memory 614 and memory 624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 624 may include a type of read-only memory (ROM) such as mask ROM, programmable ROM (PROM), erasable programmable ROM (EPROM) and/or electrically erasable programmable ROM (EEPROM). Alternatively, or additionally, each of memory 614 and memory 624 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 610 and network apparatus 620 may be a communication entity capable of communicating with each other using various proposed schemes in accordance with the present disclosure. For illustrative purposes and without limitation, descriptions of capabilities of communication apparatus 610, as a UE, and network apparatus 620, as a network node (e.g., TRP), are provided below with process 700, process 800, process 900 and process 1000.

### Illustrative Processes

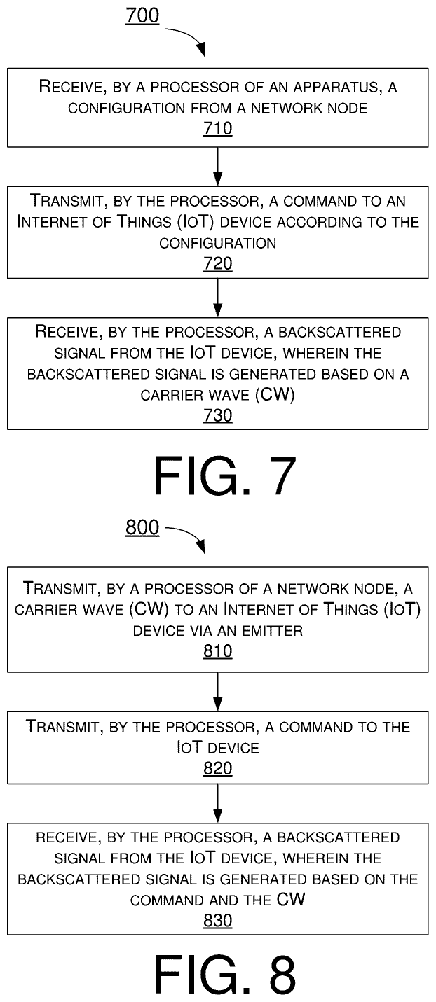

FIG. 7 illustrates an example process 700 in accordance with an implementation of the present disclosure. Process 700 may be an example implementation of above scenarios/schemes, whether partially or completely, with respect to IoT signal transmission with the present disclosure. Process 700 may represent an aspect of implementation of features of communication apparatus 610. Process 700 may include one or more operations, actions, or functions as illustrated by one or more of blocks 710, 720 and 730. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by communication apparatus 710 or any suitable reader apparatus. Solely for illustrative purposes and without limitation, process 700 is described below in the context of communication apparatus 610. Process 700 may begin at block 710.

At block 710, process 700 may involve processor 612 of communication apparatus 610 receiving, via transceiver 616, a configuration from a network node. Process 700 may proceed from block 710 to block 720.

At block 720, process 700 may involve processor 612 transmitting, via transceiver 616, a command to an IoT device according to the configuration. Process 700 may proceed from block 720 to block 730.

At block 730, process 700 may involve processor 612 receiving, via transceiver 616, a backscattered signal from the IoT device, wherein the backscattered signal is generated based on a CW.

In some implementations, process 700 may involve processor 612 transmitting, via transceiver 616, the CW to the IoT device according to the configuration.

In some implementations, the CW may be transmitted contiguously, periodically or based on a demand.

In some implementations, the configuration may be determined based on a distance or a link quality between the apparatus and the IoT device.

In some implementations, process 700 may involve processor 612 determining a power of the CW according to at least one of a distance between the apparatus and an emitter, a distance between the IoT device and the emitter, and a distance between the apparatus and the IoT device.

In some implementations, the command may comprise a timing acquisition signal, and wherein the timing acquisition signal comprises at least a start-indicator part and a clock-acquisition part.

In some implementations, the command may indicate an IoT UL type associated with an UL timing.

In some implementations, the backscattered signal may comprise a preamble, a header, a handle, and a CRC code.

In some implementations, the configuration may be received through at least one of an RRC signaling, an MAC CE, and a DCI from the network node.

FIG. 8 illustrates an example process 800 in accordance with another implementation of the present disclosure. Process 800 may be an example implementation of above scenarios/schemes, whether partially or completely, with respect to IoT signal transmission with the present disclosure. Process 800 may represent an aspect of implementation of features of network apparatus 620. Process 800 may include one or more operations, actions, or functions as illustrated by one or more of blocks 810, 820 and 830. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by network apparatus 620. Solely for illustrative purposes and without limitation, process 800 is described below in the context of network apparatus 620. Process 800 may begin at block 810.

At block 810, process 800 may involve processor 622 of network apparatus 620 transmitting, via transceiver 626, a CW to an IoT device via an emitter. Process 800 may proceed from block 810 to block 820.

At block 820, process 800 may involve processor 622 transmitting, via transceiver 626, a command to the IoT device. Process 800 may proceed from block 820 to block 830.

At block 830, process 800 may involve processor 622 receiving, via the transceiver 626, a backscattered signal from the IoT device, wherein the backscattered signal is generated based on the command and the CW.

In some implementations, the network node may comprise the emitter.

In some implementations, the command may comprise a timing acquisition signal, and wherein the timing acquisition signal may comprise at least a start-indicator part and a clock-acquisition part.

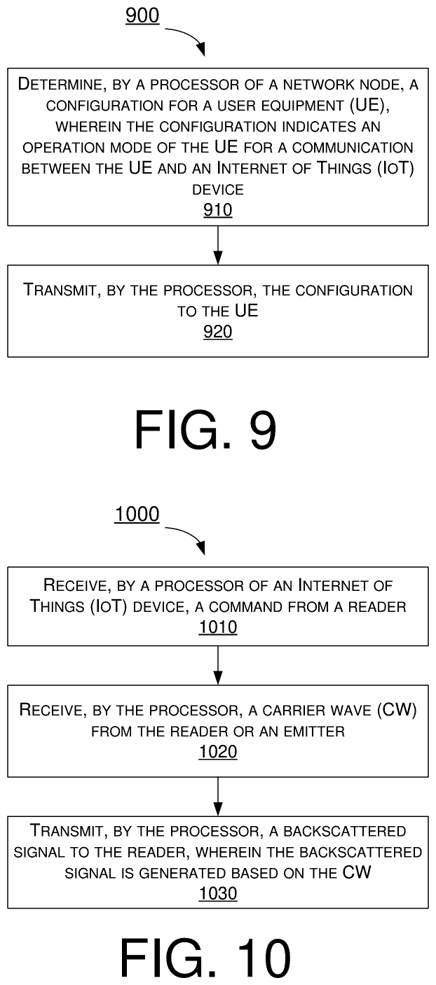

FIG. 9 illustrates an example process 900 in accordance with another implementation of the present disclosure. Process 900 may be an example implementation of above scenarios/schemes, whether partially or completely, with respect to IoT signal transmission with the present disclosure. Process 900 may represent an aspect of implementation of features of network apparatus 620. Process 900 may include one or more operations, actions, or functions as illustrated by one or more of blocks 910 and 920. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by network apparatus 620. Solely for illustrative purposes and without limitation, process 900 is described below in the context of network apparatus 620. Process 900 may begin at block 910.

At block 910, process 900 may involve processor 622 of network apparatus 620 determining a configuration for a UE, wherein the configuration indicates an operation mode of the UE for a communication between the UE and an IoT device. Process 900 may proceed from block 910 to block 920.

At block 910, process 900 may involve processor 622 of network apparatus 620 transmitting, via transceiver 626, the configuration to the UE.

In some implementations, the configuration may indicate that the UE is a reader to provide a command to the IoT device.

In some implementations, the command may comprise a timing acquisition signal, and wherein the timing acquisition signal comprises at least a start-indicator part and a clock-acquisition part.

In some implementations, the command indicates an IoT UL type associated with an UL timing.

In some implementations, the configuration may indicate a resource for the UE to transmit an IoT DL signal to the IoT device and receive an IoT UL signal from the IoT device via a higher-layer signaling or an L1 signaling.

In some implementations, the configuration may indicate that the UE is an emitter to provide a CW to the IoT device.

In some implementations, the configuration may be determined based on a distance or a link quality between the UE and the IoT device.

In some implementations, the configuration may be transmitted through at least one of an RRC signaling, an MAC CE, and a DCI.

FIG. 10 illustrates an example process 1000 in accordance with another implementation of the present disclosure. Process 1000 may be an example implementation of above scenarios/schemes, whether partially or completely, with respect to IoT signal transmission with the present disclosure. Process 1000 may represent an aspect of implementation of features of communication apparatus 610. Process 1000 may include one or more operations, actions, or functions as illustrated by one or more of blocks 1010, 1020 and 1030. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by communication apparatus 610 or any suitable IoT device. Solely for illustrative purposes and without limitation, process 1000 is described below in the context of communication apparatus 610. Process 1000 may begin at block 1010.

At block 1010, process 1000 may involve processor 612 of communication apparatus 610 receiving, via transceiver 616, a command from a reader. Process 1000 may proceed from block 1010 to block 1020.

At block 1020, process 1000 may involve processor 612 receiving, via transceiver 616, a CW from the reader or an emitter. Process 1000 may proceed from block 1020 to block 1030.

At block 1030, process 1000 may involve processor 612 transmitting a backscattered signal to the reader, wherein the backscattered signal is generated based on the CW.

In some implementations, the command may comprise a timing acquisition signal, and wherein the timing acquisition signal comprises at least a start-indicator part and clock-acquisition part. The command may indicate an IoT UL type associated with an UL timing.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a configuration from a network node;
transmitting, by the processor, a command to an Internet of Things (IoT) device according to the configuration; and
receiving, by the processor, a backscattered signal from the IoT device, wherein the backscattered signal is generated based on a carrier wave (CW).

2. The method of claim 1, further comprising:
transmitting, by the processor, the CW to the IoT device according to the configuration.

3. The method of claim 2, wherein the CW is transmitted contiguously, periodically or based on a demand.

4. The method of claim 1, wherein the configuration is determined based on a distance or a link quality between the apparatus and the IoT device.

5. The method of claim 1, further comprising:
determining, by the processor, a power of the CW according to at least one of a distance between the apparatus and an emitter, a distance between the IoT device and the emitter, and a distance between the apparatus and the IoT device.

6. The method of claim 1, wherein the command comprises a timing acquisition signal, and wherein the timing acquisition signal comprises at least a start-indicator part and a clock-acquisition part.

7. The method of claim 1, wherein the command indicates an IoT uplink (UL) type associated with an UL timing.

8. The method of claim 1, wherein the backscattered signal comprises a preamble, a header, a handle, and a cyclic redundancy check (CRC) code.

9. The method of claim 1, wherein the configuration is received through at least one of a radio resource control (RRC) signaling, a medium-access-control control-elements (MAC CE), and a downlink control information (DCI) from the network node.

10. A method, comprising:
transmitting, by a processor of a network node, a carrier wave (CW) to an Internet of Things (IoT) device via an emitter;
transmitting, by the processor, a command to the IoT device; and
receiving, by the processor, a backscattered signal from the IoT device, wherein the backscattered signal is generated based on the command and the CW.

11. The method of claim 10, wherein the network node comprises the emitter.

12. The method of claim 10, wherein the command comprises a timing acquisition signal, and wherein the timing acquisition signal comprises at least a start-indicator part and a clock-acquisition part.

13. A method, comprising:
determining, by a processor of a network node, a configuration for a user equipment (UE), wherein the configuration indicates an operation mode of the UE for a communication between the UE and an Internet of Things (IoT) device; and
transmitting, by the processor, the configuration to the UE.

14. The method of claim 13, wherein the configuration indicates that the UE is a reader to provide a command to the IoT device.

15. The method of claim 14, wherein the command comprises a timing acquisition signal, and wherein the timing acquisition signal comprises at least a start-indicator part and a clock-acquisition part.

16. The method of claim 14, wherein the command indicates an IoT uplink (UL) type associated with an UL timing.

17. The method of claim 13, wherein the configuration indicates that the UE is an emitter to provide a carrier wave (CW) to the IoT device.

18. The method of claim 13, wherein the configuration is determined based on a distance or a link quality between the UE and the IoT device.

19. The method of claim 13, wherein the configuration is transmitted through at least one of a radio resource control (RRC) signaling, a medium-access-control control-elements (MAC CE), and a downlink control information (DCI).

20. The method of claim 13, wherein the configuration indicates a resource for the UE to transmit an IoT downlink (DL) signal to the IoT device and receive an IoT uplink (UL) signal from the IoT device via a higher-layer signaling or a layer 1 (L1) signaling.
